(19) United States
(12) Patent Application Publication
(10) Pub. No.: US 2025/0165934 A1
(43) Pub. Date: May 22, 2025

(54) Method of Having Credit/Debit Card Receipts Stored at Credit Card Companies

(71) Applicant: Joel Veres, Mahone Bay (CA)

(72) Inventor: Joel Veres, Mahone Bay (CA)

(21) Appl. No.: 18/611,894

(22) Filed: Mar. 21, 2024

Related U.S. Application Data
(60) Provisional application No. 63/600,697, filed on Nov. 19, 2023.

(51) Int. Cl. G06Q 20/04; G06Q 20/20; G06Q 40/02

(52) U.S. Cl. CPC G06Q 20/047; G06Q 20/20; G06Q 40/02

(57) ABSTRACT

Having an option for credit card users, at the time of sale, when paying with credit or debit card, to have the store receipt included with, their monthly statement and/or emailed to the email address(es) attached to their financial institution account, the method is comprised of a point-of-sale system that registers goods and/or services, comprising a transaction receipt, and the credit card number of user, allows the credit card user to input if he/she wants the receipt saved, the point of sale systems sends data to the credit approval system for approval, upon approval the point of sales information is either sent immediately to the server associated with the credit card, or is sent to who a local server who later sends the data to appropriate credit card server, the credit card server sends the data to the credit card's financial institution who saves the receipt under the credit card user's account, and then includes the receipt in the credit card users statements, and ongoing online transaction record.

### FIELD OF THE INVENTION

The invention pertains to utilizing modern point of sale (POS) systems for capturing complete receipts and forwarding them to a safe location so they are never lost. More specifically the store receipts will be saved on the credit card server of the financial institution that issued the credit card that is used in a transaction, and forwards to the user of the credit and/or debit card on their statement(s), giving the credit card users easy access to their receipts. The present invention relates generally to the interaction of the credit card user at the POS, closed networks, electronic and computer arts, and, more particularly, to apparatuses and methods for receiving electronic payment receipts and management of the electronic receipts, at a Point-of-sale terminal.

### BACKGROUND

Cards which can be read electronically, typically through a magnetic strip, chip or embedded circuit, are commonplace in our society. However, currently, paper print outs of a transaction, such as a consumer/merchant purchase, are the norm. Occasionally, at the point-of-sale, a the credit card user may select an electronic receipt be sent to his or her email by typing in the email on the point-of-sale transaction device/terminal machine. However, this presently exists only on a transaction by transaction basis, elected in real-time, each time, by the customer, in conjunction with only the reader point-of-sale device. Further, there is no general consensus on how, when or where the information is sent or stored.

What is changing in the market that makes securely storing credit card receipt(s) on the Internet possible are the new era POS systems. POS systems are mostly designed for the merchant offering credit card payments, giving them customer data that helps with inventory management and other business related activities. To meet this newer use POS systems capture all the receipt data to put into their data systems. So POS systems are storing receipt data. At the same time POS systems are adding email capabilities, so sending receipt data out is possible, some POS systems email copies of the receipt to customers. So with the era of POS systems, storing credit card receipts at central locations, which in this application are the financial intuitions holding the credit card debt, is possible.

Thus, the present invention provides for both the technical method and system for enabling the credit card to have a specific and unique identifier that identifies that the credit card user wants receipt saved, which triggers an electronic copy of the receipt to be sent to one or more locations, stored in one or more locations, or otherwise made available to the Cardholder or other person with permission in electronic format.

### SUMMARY OF THE INVENTION

### Ways it Will Work:

Credit card companies will optionally add new data on chips, requesting receipts be saved by the credit card companies, credit card chip readers will also need to have their readers pick up this new data on the chip card.

Vendors/Suppliers/Retailers/Restaurants and others will have POS will have all the goods and services available for purchase, and record for a credit card user all of the goods and purchased on a receipt, The POS systems registers when a user wants to have their receipt, then sends the receipt to the processing center associated with the credit card, the processing center, which then sends the receipt data to the financial institution that issued the card.

Through the POS system, detecting when a purchase is made, what the credit card users credit card number is and entering with the receipt whether or not the credit card user wants to send a receipt for storage to later be attached to their statement. This may be done through the data stored on the chip, or by an input method on the POS device. In many cases, the point of sale system sends all the items purchased to the printer so a receipt can be printed in the store. The point of sale system also sends the amount owed for the transaction to the credit/debit terminal. Software takes the transaction details of what the point of sale system was sending to the receipt printer and sends it along with (like an email attachment) the credit/debit terminal information to the processing center who the send the information to the financial institution that issued the card. Being an attachment, when you click on the transaction on your financial statement it would open up the full receipt. Being able to make the full receipt an attachment travelling the same connection points as the credit/debit transaction, would offer safety for the consumer. If the information is being sent between those different devices in the store, the software will put all that information together as one package going to the credit card companies processing centers which in turn is going to the appropriate financial institution.

Registering through a processor with a server at the credit card processing center that communicates with the point of sale system and, the server also receives the receipt data sent to the store's printer, including the user's credit card number. This server can be at a location of the seller, in which case information is later sent to the credit card company's designated server or it can be sent immediately to the credit card company's designated server.

Storing the receipt and the credit card number at the credit card company's designated server.

The credit card company forwards the information to the financial institution that issued the credit card.

The financial institution decide to store the receipt data on a designated server, or it can decide to immediately store the receipt in the credit card users account data.

When a server prepares a credit card company's statement for a user, the server will select from the receipt storage location, receipts associated with the credit card number.

When a server has an online inquiry from a user, the server will select from the receipt storage location, receipts associated with the credit card number.

Through a user's account with the user's financial institution the user will have the option of having the full store receipt attached to their statement and/or having the full store receipt emailed to their designated email address(es) of the account.

On the credit or debit card statement the purchase will be able to be opened further through a link or web page address showing the full store receipt of your purchase.

Whether using ‘Tap’ to pay for the purchase of inserting your credit or debit card you will be shown on a screen, as shown in FIG. 1 the option to have the store receipt attached to your credit or debit card statement.

The Embodiments Of The Invention In Which An Exclusive Property Or Privilege Is Claimed Are Defined As Follows:

1. Changing the information on chips to identify users who want their receipts saved at the credit card company.

2. Changing chip readers to pick up the new data on chips.

3. Allowing the credit card user, on a Point of Sales Device, the option of have their detailed receipts stored and later sent to them through email or attached to their credit card/debit card statements. This applies when for credit card users do not have reconfigured chips or the chip reader has not been reconfigured.

4. Attaching the full store receipt when paying with your credit card to your credit card statement.

5. Attaching the full receipt after paying with your debit card to your debit card statement.

6. Having the full store receipt emailed to the user's designated email address(es) on record at the user's financial institution from which the credit or debit card is issued.

7. Credit card(s) having a chip embedded that will alert stores to send the full receipt to the credit card issuer.

8. Debit card(s) having a chip embedded that will alert stores to send the full receipt to the credit card issuer. Pinpad(s) accepting card payments will send to the card companies the full store receipt when purchase is complete and customer has chosen the option to do so.

9. Card companies when receiving full store receipt from merchant(s) will attach receipt to consumer(s) card statement.

### BRIEF DESCRIPTION OF FIGURES

FIG. 1 shows a hand held POS (point of sale) device.

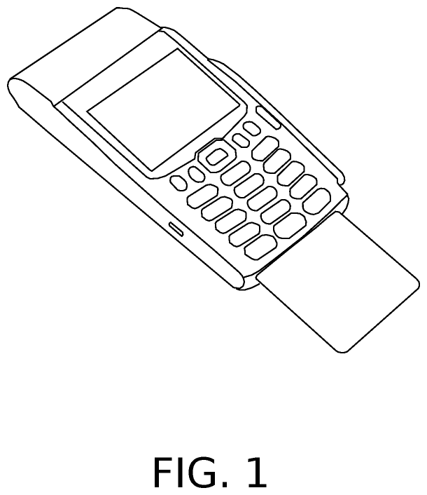

FIG. 2 shows a tablet which can be used by a server or at the register.

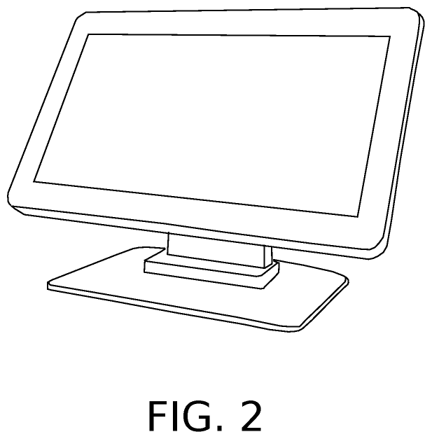

FIG. 3 show the system, with the POS 1 device sending billing and receipt information to a local server and storage unit 2. The POS system may also gather receipt data and sent that data to the Processing Center 3 for large credit card networks like Visa, and Processing Center sends the receipt amount, to the financial institution 4 who issued the credit card, who then sends out statements with receipts, and who may make receipts available online.

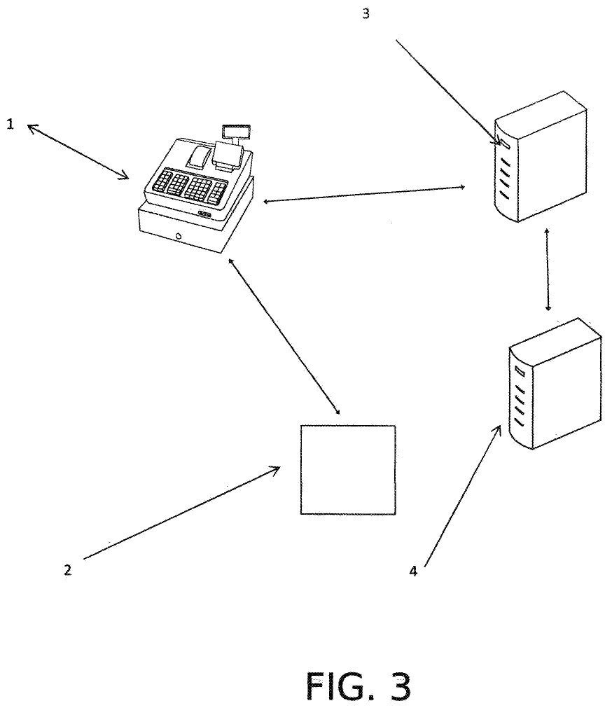

### TECHNICAL DESCRIPTION

This method manages electronic receipts for access by the credit/debit card user. The method comprises, a method for the credit card use to opt in the system, either on the chip credit card, or through an entry on the point-of-sale system which forwards credit card receipts to credit card companies, a credit card company storage which stores receipts associated with a credit/debit card number, an administrative server, which may be the same as the storage server, that can pull the receipts and makes them available to the credit or debit card holder with their statements, and via on online portal. The point-of-sale system is configured to register all of a company's goods and/or services and to produce a detailed receipt. Non-limiting examples of products may include retail food items, retail consumable goods (clothing, home items), or particular large-scale items such as electronics or furniture. Services may also include restaurant food items and/or personal care services including hair care, skin care, spa treatments, or exercise services. The common factor between the goods and/or services is that they are regularly acquired by a user during interaction with the merchants that are utilizing the system and that these goods and/or services may be itemized through the receipt.

The local server, or credit card user server is in communication with the point-of-sale system and includes a memory device. The processor is configured to register the payment of the transaction receipt as a function of the credit card number of the credit card holder. The memory device is configured to store a data credit/debit card base with a plurality of receipt-data storage locations each receipt-data storage location associated with a credit/debit card number. The server may be housed within an individualized server incorporating the processor, but the server may also comprise separate components including the processor and the memory device that communicate over a wired/wireless connection.

In the method disclosed here, when the credit card user opts to have receipts stored, either by the chip in the credit card user's card, or through an opt in system on the POS device, when the credit card system approves the payment, the point-of-sale system forwards the credit card number and the transaction receipt to the server of the credit card company who the stores the transaction receipt within the receipt-data storage location associated with the credit card number and then forwards the information to the financial institution that issued the credit card. This transfer of the transaction receipt to a receipt-data storage location ensures that the user has access to the transaction receipt at a later date or time.

In this method traditional credit/debit cards utilizing magnetic strip and payment chip technologies may be used in addition to other wireless payment technologies. Also in this method, transmitting transaction information to a local computing storage device that can receive receiving data from the POS, in cases where the POS cannot send data directly to the credit card company server, may be a cellphone, tablet computing device, laptop or desktop computer, or wearable device that allows for the functionality and communication between the wireless storage device and the point-of-sale system and/or the server.

Although there are quite a few steps, set out here are the typical steps used in current card transactions. The purchase/payment transactions themselves are processed electronically in a matter of seconds through these basic steps shown following.

STEP ONE—In a typical face-to-face retail transaction, the Cardholder purchases goods and/or services from the merchant. An alternative to STEP ONE, is a person signing on to make an internet purchase through an internet store, like eBay, Amazon, PayPal or other internet card processors. In this initial step for this application, the credit card user indicates that they wish for the receipt stored at the credit card issuer, for eventual retrieval by the credit card user, or the financial institution that issued the credit card for attachment to a statement. In this patent application the credit card company refers to either the company itself, such as Visa or MasterCard, or another organization that the credit card company arranges to handle stored data and statements to the cred card user.

STEP TWO—In the case of a point-of-sale purchase, the merchant or Cardholder slides the card through or into the electronic point-of-sale (point-of-sale) terminal, which reads the information off of the magnetic strip or magnetic chip and transmits the transaction through a standard phone line or other transmission device to the financial institution that issued the card, or to the credit card processing center of companies such as Visa, MasterCard, Discover, and/or American Express, each of whom have contracts with merchants to handle credit card transactions through their processing networks. These Processing Networks have policies for issuing credit cards and processing credit card transactions, and typically use Payment Card industry (“PCI”) Data Security Standards.

STEP THREE—If the authorization request is sent first to the credit card processing center the processors route the authorization request to the Issuing Bank for approval.

STEP FOUR—If the transaction is approved, it is “authorized” and the Issuing Bank transmits an authorization code back to the Processor association.

STEP SIX—The Acquiring Bank sends the authorization code (or other response) to the merchant's point-of-sale terminal, which prints out a receipt that the cardholder signs. (The Issuing Bank then bills the Cardholder, and later, the Cardholder pays the bill.)

These are new the steps that are included in this method.

STEP SEVEN—When a credit card user requests their receipts be stored and included in their statements, the copy of the complete receipt is either sent immediately to the credit card company identified with the credit card number, which forwards it to the financial institution that issued the card, or sends in a bulk electronic transfer either at the end of the day or another chosen time to the credit card processor, where it is stored for retrieval by the credit card processor or it is forwarded to the financial institution who then stores the transaction information, including a copy of the receipt.

STEP EIGHT—The credit card holder server's processor can either send out a copy of the transaction receipt with the statement or it can send out the transaction receipts on the request of the server or the credit card user or it can make the receipt available on-line with proper security.

I claim:

1. a method of storing credit/debit card receipts at a financial institution that issued the credit card for retrieval either with statements, or upon a credit card holder request:
using a point of sale payment system capable of;
alerting the financial institution that issued the credit card/debit registering what credit card/debit card users want to have their receipts stored at the financial institution and be available as a copy with statements or available upon request;
registering goods and/or services, comprising the electronic transaction receipt associated with a sale;
communicating with the existing credit approval process and receiving approval;
upon approval for a transaction purchase, the POS payment system will store credit card numbers and a graphical representation of an electronic transaction receipt;
the POS system will send the transactional receipt with the credit card/debit card number for the credit card/debit card used for purchase to the Processing Center associated with the credit card company used by the financial institution that issued the credit card number;
the financial institution associated with the credit card/debit card number and will receive the transactional receipt and store the transaction receipt and its associated credit card number on a server;
the server, either with its own processor, or its connected processor, will retrieve transaction receipts on request, either to attach to a statement or to supply the receipt(s) upon a credit card/debit card holder's request.

2. The method of claim 1, wherein each credit card/debit card number and transactional receipt has more than one associated receipt-data storage location, wherein the processor is further configured to store the transaction receipt within each associated receipt-data storage location.

3. The method of claim 1, wherein the card holder receiving payment device includes a wireless computing device in communication with the point of sale system and the server.

4. The method of claim 3, wherein the wireless computing device further includes a memory device, the memory device including at least one receipt-data storage location, wherein the wireless computing transaction receipt associated with the credit card number can store the transaction receipt within at least one receipt-data storage location.

5. The method of claim 1, where the credit card user indicates that the financial institution that issued the credit card/debit cards stores receipt data on a chip on the credit card.

6. The method of claim 1 where point of sales card readers add the capability or reading on a chip that the credit card/debit card user wants the receipts associated with the credit stores and available either on statements or on-line.
